(19) United States
(12) Patent Application Publication
(10) Pub. No.: US 2007/0144140 A1
(43) Pub. Date: Jun. 28, 2007

(54) High propellant mass fraction hybrid rocket propulsion

(76) Inventors: Martinus M. Sarigul-Klijn, Dixon, CA (US); Nesrin Sarigul-Klijn, Dixon, CA (US)

Correspondence Address: N & M Sarigul-Klijn, PO BOX 1386, DIXON, CA, 95620, US

(21) Appl. No.: 11/314,467

(22) Filed: Dec. 22, 2005

(51) Int. Cl. F02K 9/68

(52) U.S. Cl. 60/200.1; 60/219

(57) ABSTRACT

A chemical hybrid propulsion motor can be comparable in performance to a solid motor or liquid fueled engine if it uses cryogenic nitrous oxide as its oxidizer and a pump such as a turbopump to transfer the oxidizer into the motor case. Cryogenic nitrous oxide (at about −100° F.) has high density which will reduce oxidizer tank volume and weight and this oxidizer combusts at a high oxidizer to fuel (O/F) ratio which minimizes motor case size and weight. The high O/F would also reduce unburnt fuel sliver and hence residual propellant weight. The pump not only transfers the oxidizer into the motor at increased chamber pressure that in turn increases specific impulse, but it also significantly reduces oxidizer tank pressure and weight as compared to a pressure fed motor.

### CROSS REFERENCES TO RELATED APPLICATIONS

This application claims the benefit of U.S. Provisional Patent Application No. 60/637850, filed Dec. 20, 2004, the entire disclosure of which is incorporated herein by reference.

### STATEMENT AS TO RIGHTS TO INVENTIONS MADE UNDER FEDERALLY SPONSORED RESEARCH AND DEVELOPMENT

Not applicable.

### REFERENCES CITED

U.S. Patent Documents

| | | | |
|---|---|---|---|
| 6,880,326 | April 2005 | Karabeyoglu, et al. | 60/251 |
| 6,684,624 | Feburay 2004 | Karabeyoglu, et al. | 60/251 |
| 6,865,878 | March 2005 | Knuth, et al. | 60/258 |

### OTHER REFERENCES

1. I-Shing Chang, “Investigation of Space Launch Vehicle Catastrophic Failure,” AIAA Paper, July 1995. (AIAA 95-3128)
2. U.S. Department of Transportation, “Hazard Analysis of Commercial Space Transportation,” May 1988.
3. Eger, Edmond I., “Nitrous Oxide,” Elsevier Publishing, 1985.

### BACKGROUND OF THE INVENTION

The present invention relates to improving the propellant mass fraction of hybrid rockets and the application of such a propulsion system to space launch vehicles and in-space propulsion.

There are three major types of chemical rocket engines. Liquid propellant engines use a separate oxidizer, for example, liquid oxygen; and a separate fuel, for example, kerosene or liquid hydrogen. Solid propellant motors use a solid propellant grain that contains both the oxidizer and the fuel. Finally, a hybrid motor typically uses a liquid oxidizer such as nitrous oxide or liquid oxygen and a separate solid fuel grain such as rubber or plastic.

Both liquid rocket engines and solid rocket motors can catastrophically explode. For example, the estimate for the Space Shuttle's liquid fueled main engine, currently believed to be the most reliable liquid fuel engine, is one explosion every 1530 sorties per engine. For the Shuttle's solid rocket boosters, believed to be the most reliable solid motor, it is one explosion every 1550 sorties per motor (Reference 1).

On the other hand, according to the Department of Defense Explosives Safety Board, hybrid motors can be fabricated, stored, and operated without any possibility of explosion or detonation (Reference 2). The usual hybrid is a cylinder of fuel with multiple longitudinal passages down the center line called ports. Oxidizer is injected at the upstream end, and reacts with the fuel as it travels down the ports, and the combustion products emerge at the downstream end of the fuel grain and then passes through a nozzle. Detonation is not possible because there isn't any way for the fuel and oxidizer to mix.

During the late 1950's and early 1960's, solids, liquids, and hybrids were investigated. Initially all three types suffered from poor performance due to poor propellant mass fractions, high propellant residuals, and low specific impulse. Liquid fueled rockets were developed because of their potential for the highest specific impulse, Isp. NASA later adopted the liquid fueled rockets such as Atlas and Titan for their manned launch vehicles. The simplicity of all-solid rockets for military applications out-weighed any safety and performance advantages that hybrid rockets had to offer. Polaris, Poseidon, Trident, Minuteman and Peacekeeper were all designed as multistage solid rockets, as were several smaller Army field rockets. As a result during the past 50 years, development of hybrids has not been at the same scale as for liquids and solids. For example, Karabeyoglu, et al. have just invented a new process for developing high regression rate propellants. Knuth, et al. have just invented a hybrid rocket engine using a vortex flow field.

Current efforts to develop hybrid rockets have been toward those that use liquid oxygen (LOX) as an oxidizer because of its high specific impulse. Specific impulse is the conventional method of comparing propellants, propellant combinations and rocket engines. Specific impulse or Isp of a rocket propulsion system is defined as the number of seconds a pound of propellant will produce a pound of thrust. For example, an Isp of 200 seconds means that a rocket engine would consume 1 pound of propellant when producing 1 pound of thrust for 200 seconds. Generally speaking, designers strive for the highest Isp they can achieve.

Development of hybrids using nitrous oxide as an oxidizer has been ignored because of its lower Isp relative to LOX (nitrous at about 270 seconds compared to LOX at 300 seconds).

The problem with Isp as a metric to compare rocket performance is that it does not consider propellant mass fraction. Propellant mass fraction, f_prop, is the mass of the propellant relative to the total vehicle mass. In general designers strive for the highest propellant mass fraction they can achieve.

Of real interest to the designer is the capability of the rocket propulsion system to accelerate the entire launch vehicle to the highest possible velocity. The rocket equation must be used to determine this. The rocket equation is given by:
delta V=Isp·g·n[1/(1−f_prop)]
where:

delta V=change in velocity

g=gravitational constant, equals 32.174 ft/secˆ2 or 9.806 m/secˆ2

1n=natural logarithm

The rocket equation combines specific impulse, Isp, and propellant mass fraction, f_prop, into one metric, ideal delta V (change in velocity).

To visualize ideal delta V imagine a segment of a launch vehicle such as a complete lower or upper stage placed in outer space. This stage would not carry any payload or carry upper stages and as such, makes this metric unique as compared to traditional orbital delta V calculations. The stage would be then be fired until fuel exhaustion. Ideal vacuum delta velocity is the change of velocity that would occur in the absence of gravity and aerodynamic drag. It incorporates parameters such as propellant combination, chamber pressure, nozzle expansion ratio, propellant tank construction, and residual propellant management, but all in one metric.

What is needed is a means to improve the performance of a hybrid propulsion system so that its delta V performance is comparable to other rocket propulsion systems.

### BRIEF SUMMARY OF THE INVENTION

This invention describes improvements to nitrous oxide hybrid rocket propulsion systems so that their performance is comparable to current solid rocket motors and liquid fueled rocket engines, while retaining a hybrid motor's greater safety.

We have identified the causes of a hybrid's poor delta V performance as its low propellant mass fraction and its high propellant residuals. A pump-fed, high oxidizer to fuel ratio (O/F), and high bulk density propellant combination can improve a hybrid's propellant mass fraction and reduce its residuals so that its performance is equal to solids and most liquid fueled rockets. Further, we have discovered that despite its slightly lower specific impulse, cryogenic Nitrous Oxide provides the highest delta V capability for such a hybrid.

### BRIEF DESCRIPTION OF DRAWINGS

No drawings.

### DETAILED DESCRIPTION OF INVENTION

Four technologies explained in this invention, applied to a hybrid rocket propulsion system, will improve a hybrid rocket's delta V performance to that equal of solid rockets and most liquid rockets. These technologies increase the performance of hybrid motors by increasing propellant mass fraction while maintaining specific impulse, Isp. The technologies are high propellant density, high oxidizer to fuel ratio (O/F), use of a propellant combination that has constant Isp over a wide O/F ratio, and a pump to feed the oxidizer into the motor case. At the same time, these technologies will retain a hybrid motor's unique safety features.

High propellant density decreases the size of the tank volume, and hence decreases the fraction of launch vehicle mass that must be devoted to tanks and motors. Dense propellants also reduce the size and weight of the flow passageways, pump size, and amount of gas (either from a gas generator or from high pressure storage bottles) to pump the propellant. Note in Table 1 that a hybrid propulsion system using cryogenic Nitrous Oxide (N2O) with HTPB (Hydroxyl-Terminated Polybutadiene—rubber) is 11% denser compared to a kerosene-liquid oxygen (RP-LOX) propulsion system, and 7% denser compared to a LOX-HTPB hybrid. A cryogenic nitrous oxide is at minus 50° F. to minus 100° F.

TABLE 1
Bulk Specific Gravity Comparisons

| | | | Bulk |
|---|---|---|---|
| | | Oxidizer to | Specific |
| Fuel | Oxidizer | Fuel Ratio | Gravity |
| Liquid Hydrogen | Liquid Oxygen | 5.5 | 0.34 |
| HTPB | Nitrous Oxide N₂O | 8.0 | 0.78 |
| Kerosene (RP) | Liquid Oxygen (LOX) | 2.7 | 1.03 |
| HTPB | Liquid Oxygen | 2.3 | 1.06 |
| Aerozine-50 | Nitrogen Tetroxide | 1.9 | 1.09 |
| HTPB | Cryogenic N₂O | 8.0 | 1.14 |
| HTPB | Hydrogen Peroxide | 7.5 | 1.30 |
| Aluminum | Ammonium Perchlorate | — | 1.76 |

A N2O hybrid has a peak Isp at a very high oxidizer to fuel (O/F) mixture ratio of 8. Only 11% of its propellant is HTPB fuel that is stored inside a heavy high-pressure motor case. The remaining 89% is nitrous oxide liquid that is stored inside a lighter weight low-pressure oxidizer tank. Also, for the same amount of propellant, the N2O booster is 93% the size of a LOX booster due to its higher bulk density. Finally, a cryogenic N2O hybrid reduces un-burnt fuel sliver by 57% of a LOX hybrid because of N2O's higher O/F ratio. Reducing fuel sliver increases propellant mass faction, i.e., the propellant that is actually burnt and used to make thrust.

A hybrid rocket's O/F mixture ratio shifts as the combustion ports increase in size during the burn. Initially, the O/F will be low (fuel rich) and shift to high (oxidizer rich) as the burn progresses. Specific impulse, Isp, does not vary significantly for a wide range of O/F ratios when N2O is used as the oxidizer. This is because approximately ⅔ of the impulse is from the exothermic decomposition of the N2O, and only ⅓ is from the combustion of the free oxygen with the fuel. In contrast, a LOX (O2) hybrid's Isp drops off dramatically either side of its peak O/F of 2.3. As a consequence, LOX hybrids have only about a short 15 second delivered Isp advantage over a N2O hybrid, rather than the somewhat misleading 34 second apparent difference seen when comparing only the peak Isp. For example, the delivered vacuum Iₛₚ for American Rocket Company (AMROC) H-1800 hybrid LOX booster, the largest hybrid rocket motor ever fired, at 250,000 lbf thrust, was 283 seconds.

Oxidizer tank pressure must be lowered to reduce tank weight. A pump can reduce oxidizer tank pressure from the 250-800 psia, typically used in a surface launched pressure-fed launch vehicle to about 40-50 psia used in a pump-fed launch vehicle. This will reduce pump-fed oxidizer tank weight by greater than 80% of pressure-fed designs. To within 10%, the performance of metallic launch vehicle tanks is independent of their size, and historically they have all weighed between 0.6 to 0.7 lb/ft³. In contrast, a recent effort to build pressure-fed tanks from modern composites resulted in tanks that weigh 4 lb/ft³, or 6 times more. Pumping also reduces residual propellants from about 7% to less than 1% by replacing high-pressure gas left in the oxidizer tank after motor burnout with a lighter, low-pressure gas.

The development of new rocket turbo pumps is often seen as a prohibitive, costly challenge. However, the development of a N2O turbo pump is expected to result in a low cost pump since the pump is: (1) only pumping a single fluid; (2) N2O characteristics do not require a gear reduction between the turbine and pump; (3) N2O is much warmer than the typical cryogenic oxidizer (LOX), i.e., N2O is cooled at minus 50 to 100° F. as compared to LOX's minus 297° F.; and (4) the pump's gas generator can be powered by decomposed monopropellant nitrous oxide, which when started, the decomposition of N2O is self-sustaining. Finally, the efficiency of a turbo pump that pumps a single fluid will be higher than those used in typical bi-propellant liquid rockets because the turbine and pump can be matched.

The multi-use and monopropellant characteristics of N2O make it ideal as an oxidizer, as a gas generator propellant, and for tank pressurization. In contrast, a bi-propellant liquid-fueled engine requires two separate fluids for their gas generator, and either heavy high pressure helium tanks or a separate heat exchanger to vaporize fluids for tank pressurization. These additional components have multiple, significant, negative repercussions on inert weights.

Pump-fed LOX hybrids are more complex, costly and risky than pump-fed N2O hybrids. LOX hybrids require a separate fuel for their gas generator. Because a separate tank is needed for gas generator fuel, a separate pressurant tank is also required. Finally, a separate heat exchanger is required to vaporize fluids for oxidizer tank pressurization. These additional components make pump-fed LOX hybrids' weight greater than a cryogenic N2O hybrid.

As a result of these factors, the ideal delta V performance of hybrid using cryogenic nitrous oxide is about 3,600 feet per second better than that of hybrid using liquid oxygen, see Table 2.

TABLE 2
Example of Ideal delta V Calculation

| | LOX | Nitrous |
|---|---|---|
| | Hybrid | Hybrid |
| Inputs | | |
| Propellant Mass (lb) | 40,000 | 40,000 |
| O/F ratio | 2.3 | 8 |
| Fuel Density (lb/ft\hat{ }3 | 58 | 58 |
| Fuel Volumetric Loading Fraction | 0.65 | 0.65 |
| Motor Pressure (psi) | 500 | 500 |
| Motor pV/w (psi ft\hat{ }3/lb) | 0.010 | 0.010 |
| Oxidizer Density (lb/ft\hat{ }3) | 71.1 | 75.6 |
| Oxidizer Tank Volumetric Density (lb/ft\hat{ }3) | 0.93 | 0.93 |
| Ideal Peak Isp (sec) | 326.1 | 291.2 |
| Delivered Isp Efficiency | 0.9 | 0.92 |
| Fuel Residual Fraction | 0.05 | 0.05 |
| Motor Calculations | | |
| Fuel Mass (lb) | 12,121 | 4,444 |
| Loaded Fuel Density (lb/ft\hat{ }3) | 37.7 | 37.7 |
| Fuel Volume (ft\hat{ }3) | 321.5 | 117.9 |
| Motor Volumetric Density (lb/ft\hat{ }3) | 5.0 | 5.0 |
| Motor Weight (lb) | 1,608 | 589 |
| Fuel Residual (lb) | 606 | 222 |
| Oxidizer Tank Calculations | | |
| Oxidizer Mass (lb) | 27,879 | 35,556 |
| Oxidizer Tank Volume | 392.1 | 470.3 |
| Tank Weight (lb) | 365 | 437 |
| Inert Mass Calculations | | |
| Total Inert Weight (lb) | 2,578 | 1,249 |
| Inert Mass Fraction | 0.061 | 0.030 |
| Isp Calculations | | |
| Delivered Isp (sec) | 293.5 | 267.9 |
| Ideal Delta V Calculations | | |
| Ideal delta V (fps) | 26,501 | 30,169 |
| Volume | | |
| Total Volume (motor & oxidizer tank) (ft\hat{ }3) | 713.6 | 588.2 |

Nitrous oxide has many characteristics that make it a very safe and easy to use oxidizer as compared to other oxidizers such as liquid oxygen, LOX. Nitrous oxide is also known as “laughing gas”, dinitrogen oxide, or dinitrogen monoxide and is a molecule of two atoms of nitrogen combined with one atom of oxygen (N₂O). It is a colourless, non-toxic, liquefied gas with a slightly sweet taste and odor. When inhaled it produces insensibility to pain preceded by mild hysteria, sometimes laughter. The principal use of nitrous oxide is as an anesthetic in surgical operations of short durations. It is also used as a propellant in food aerosols, particularly whipped cream. Nitrous Oxide is non-corrosive and may be used with common structural materials. It is stable and comparatively non-reactive at ordinary temperatures to such substances as ozone, hydrogen, the halogens, and alkali metals. Its Department of Transportation (DOT) classification is non-flammable, compressed gas (Class 2.2) and it is labeled as “non-flammable.” Nitrous Oxide can be decomposed into nitrogen and oxygen by heating above 520° C. (968° F.). Chemical composition of the decomposition products is 36.3% oxygen and 63.7% nitrogen. A catalyst can accelerate the decomposition process. Nitrous oxide supports combustion at elevated temperatures (Reference 3).

N2O has been used in hybrid rockets before. Typically it is used near room temperature. It has never been used at cryogenic temperatures. At room temperature, nitrous oxide has a vapor pressure of about 700 psia. Evaporation of nitrous oxide can provide the pressure necessary to feed the oxidizer through the motor. This method is used in high-powered model rockets. It suffers from relatively low Iₛₚ (about 210 seconds) and high residuals because the oxidizer tank is filled with very cold and dense nitrous oxide gas at burnout.

Hybrid rockets using cryogenic nitrous oxide have many potential applications. Hybrid motors could replace the current strap-on solid boosters used on the Atlas V and Delta IV SLVs. Hybrids can be throttled to low thrust and proper operation can be verified prior to liftoff. Unlike solids, hybrids can be shut down if they are not operating properly. There is little reason to expect them to fail during flight because of their inherent tolerance to defects. Historically, solid failures are catastrophic, mostly due to defects in the solid grain or grain bond to the outer case, problems that do not cause catastrophic failures in hybrids.

Hybrid motors using cryogenic nitrous oxide could replace the current two-stage solid rockets used to transfer payloads from one orbit to another. Two firings are required to complete a Hohmann transfer from one orbit to another. Since solids cannot be throttled, two stages are required. A hybrid can be started and stopped repeatedly.

Hybrid motors using cryogenic nitrous oxide could provide safe and reliable propulsion for both the orbital maneuvering system (OMS) and perhaps for the Reaction Control System (RCS) engines for NASA's new Crew Exploration Vehicle.

Hybrid motors using cryogenic nitrous oxide could provide safe propulsion for the first stage of a two-stage to orbit reusable launch vehicle that would ultimately replace the Space Shuttle.

Hybrid motors using cryogenic nitrous oxide may make launching nuclear power plants into orbit acceptable to the public. Small nuclear power plants are currently in development for deep space missions.

I claim:

1. A hybrid rocket propulsion system that uses cryogenic nitrous oxide (at about from 0 deg F. to negative 120 deg F.) as its oxidizer.

2. A hybrid rocket propulsion system that uses:
a. Cryogenic nitrous oxide (at about 0 deg F. to negative 120 deg F.) as its oxidizer.
b. A pump such as turbopump to transfer the cryogenic nitrous oxide into the motor case.

3. Propelling a vehicle in space using the propulsion method of claim 1 or 2.

4. Increasing the performance of launch vehicles using the propulsion method of claim 1 or 2.
